(19) United States
(12) Patent Application Publication
(10) Pub. No.: US 2025/0198227 A1
(43) Pub. Date: Jun. 19, 2025

(54) Downward Propelling Water-Tight Sloped Threshold Sill Connection

(71) Applicant: DaRa Industries, LLC., Upland, CA (US)

(72) Inventor: Dale Gepfrey, Upland, CA (US)

(21) Appl. No.: 18/984,533

(22) Filed: Dec. 17, 2024

Related U.S. Application Data
(60) Provisional application No. 63/611,513, filed on Dec. 18, 2023.

(51) Int. Cl. E06B 1/70; E06B 7/14

(52) U.S. Cl. CPC E06B 1/70; E06B 7/14

(57) ABSTRACT

A window, patio door, entry door, store front window frame work and door comprising an exterior and interior frame work having linear connections of exterior main frame profile sloped downward angled threshold sill. The door comprises an exterior main frame profile sloped downward saddle threshold sill meeting the requirements of American Disability Act (ADA). This exterior framework comprises two-way connections, three-way connections and four-way connections all of which connect to multiple linear exterior and interior profiles that when connected form air-tight and water-tight seals and provides an all transparent translucent exterior glass esthetic look. The connection sections comprise different ends wherein each of the ends sandwiches a portion of a respective linear rail therebetween. The interior framework includes a header, a sill, and a vertical jamb that comprise cross-sectional configurations that are compatible with the profile sloped downward angled sill connection pieces.

This application claims priority to, and the benefit of the earlier filing date of US provisional patent application entitled “Downward Propelling Water-Tight Sloped Threshold Sill Connection”, filed on Dec. 18, 2023, Ser. No. 63/611,513, pursuant to 35 USC 119, the contents of all of which are incorporated herein by reference.

### BACKGROUND

### Field of the Technology

The present invention relates to windows and doors, specifically doors or windows that require downward propelling water-tight sloped threshold sills. This connection can be made to windows and doors that would benefit from downward angled threshold sills or self-draining threshold sills that propel exterior or interior moisture away from the structure without any limitations on linear material chosen.

### Description of the Prior Art

Presently some windows and doors are manufactured with flat sills that incorporate water sluice systems. During the initial installation and shortly thereafter, water drainage towards the exterior structure can be achieved. Although, after a period of time, dirt, sand, and other debris accumulate on interior and exterior portions of these flat sills. Note, accumulation can vary depending on directional positioning, wind, sun and other uncontrollable environmental conditions. Accumulated dirt, sand and debris then flow through this window or door water sluice system which can also be referred to as “water weep-hole system”. The lineal, profile parts that make up this sluice system can have baffles, channels, gates, notches and the like on interior and exterior frame or sash portions of extruded lineal, profile pieces. During this water travel process, debris accumulates and clogs or dams up the sluice system. When this occurs, water can back up and begin to overflow the flat sill portion which will drain towards the interior structure. This can go undetected for undetermined periods of time causing interior water damage and structural wood rot. In later years, often times wood products were the material of choice which this new embodiment can accommodate. The manufacturing connection process on wood products came with milled sloped downward angled threshold linear pieces connecting to vertical jambs that were also milled out on sill end to nest with downward angled sloped sills or threshold caps.

However, the industry has developed a large variety of materials to accomplish new architectural demands. One component can be constructed with multiple linear profile materials. It is not necessary to keep one common wall in the two linear extruded profiles to be connected, heat fused or vinyl welded. There is no need for secondary machining, notching and cutting for connecting one 45 degree cut linear profile to another 45 degreed cut linear profile with sloped sill or threshold cap with downward angled sill profile due to its compound angle. During the 45 degree cutting process to a sloped sill linear profile the mitered cut turns into a compound angle. In the window and door industry most common material choices can be wood, vinyl, aluminum, fiberglass, steel, and other proprietary composites not limited to these materials. Connection limitations arise when attempting to join different materials or unlike materials to each other. Individual exterior and interior frame product squareness is paramount, just as interior sashes or movable panels to operate and seal within the frame members thus removing the need for any added seals, seal pads or sealants. The current invention does not require any heating or melting, therefore it can hold very accurate squareness and very close tolerances thus allowing all interior moving seal parts to operate within exterior frame air-tight and water tight.

Along with these close tolerances and improved product performances this new embodiment art opens opportunity for new architectural exploration/demands which ultimately can lower over-all energy consumption and building costs. This new pre-molded connection embodiment will allow water-tight seals and gravity to perform proper water drainage away from any structure with no material choice limitations.

Teodorovich U.S. Pat. No. 8,443,554 B1 (2013) according to Teodorovich under “Field of Invention” shows a sill pan flashing used for doors or windows where the sill pan drains accumulated moisture. This sill pan description reads “Variable size door and window sill pan with drain” comes in three pieces that covers the bottom U shape portion for the rough opening of door or window. Prior to installation you measure the rough opening at the sill end and cut the bottom portion of U shape accordingly. Next step you place 15A referred to as “right corner element” on the right side of U. Next step would be doing the same thing to 15B referred to as “left corner element”. The next step, insert complete window or door on top of this U shaped flashing. Therefore this should not be considered “Sloped sill water-tight window and door connections/corners” but clearly what they are which is sill pan flashing. The purpose for this additional rough opening sill pan flashing is to correct what the window, door or any other product installed in structure where intended to accomplish without the additional sill pan flashing, which new embodiment accomplishes.

U.S. Pat. No. 4,363,350 to Beckerer (1982) shows Self-Draining Boat Window. This window has sloped sill that's connected with the mounting flange or frame of window. Beckerer refers to it as “spigot” or number 18 labeled spigot wall connecting with the mounting flange. This spigot wall that connects with the mounting flange is similar to a sloped sill adapter also referred to as sill pan flashing which some home and commercial installations of windows and doors require. Although when installing sloped sill adapter this normally takes place after rough opening has been prepared and window or door sets inside or on top of adapter. This molded spigot wall is installed on interior portion of the molded frame which is unlike the standard sill adapter we are familiar with today or explained above. Molded frame component and spigot portions that are to be used are explained to be that of “Plexiglass DR” although think they meant polycarbonate. Regardless, this removes frame connectors of any kind and can make size change overs more difficult and expensive. Because this product is installed on a boat hull and is exposed to splashing water it opens and closes towards the interior which is opposite form housing or commercial applications where the opening is towards the exterior.

Another method used to prevent water from entering the inside of a doorway or window is explained in Header U.S. Pat. No. 11,542,746 B2 (2023) which, unlike a sill adapter or sill pan flashing that gets installed under the window or door frame, is a subsill. This subsill is placed between the window or door frame sill that touches the floor or in a stacking or store front application goes between the next product below which could be window, door or floor. They explain this extrusion piece as not exactly draining water away from the structure although providing a series of baffles or pressure chambers improvising a longer way to travel than the most direct way referred to as “circuitous”. This longer way to travel not only makes it difficult for water drainage to penetrate the interior portion of the structure also helps eliminate air infiltration, which is very important for product U factor ratings. In short, this subsill provides a series of obstacles that facilitate in making it more difficult for air or water penetration in a store front window application. This was accomplished by lengthening the water and air path, creating a series of pressure chambers extending lengthwise and implementing ball check valve system. The subsill is not able to shield or deflect all water or air from penetrating.

However another method for water drainage is shared in U.S. Application Publication to Meyer 2023/0134444 A1 (2023) entitled “Fenestration Unit With Drainage Passage From Corner Key And Through Cladding” This featured fenestration unit happens to be a window. The description of corner they refer to is “corner key”. A large percentage of people in the industry equate this term to unseen corner or one that is placed inside two hollow pieces that cannot be seen when the 90 degree corner is completed. When this inserted corner key is used it takes two hollow pieces both cut at 45 degree angles along with inserted corner key to accomplish one completed 90 degree angle, this is what their window frame assemble requires. The new embodiment is provided with a contour shape that matches both lineal interior and exterior sections that are being joined. Therefore each linear part or profile is straight cut and joined to make one completed corner connection. This would eliminate any need for 45 degree angle cut parts. This corner key process (inserted inside hollow) is similar to what is used in joining 45 degree cut fiberglass corners today. As explained after this corner key joining process there is a frame and sill cladding apron covering process in which these items need to be 45 degree mitered as needed, machined notched and in some cases machine hole piercing. This interior corner key joining process with water/fluid drainage through corner key and cladding is multiple steps with heavy engagement of added machinery and energy requirements.

Another method used in providing positive water drainage system away from the structure on a window sill is described U.S. Pat. No. 4,793,114 to Pacca (1988). Pacca describes a window sill extrusion made out of poly vinyl chloride (PVC) for replacement windows that can be cut to desired length and used at sill end. Similar to Slocomb Jr., Design U.S. Pat. No. 285,610 (1986) although Pacca's single piece of PVC extrusion has a “casing slot” (42) that is formed under the screen channel (40). This casing slot can hold multiple different widths or desired widths of casings (50) after insertion this would extend water drainage collected from screen or screen cloth run off even further away from structure. This PVC extrusion has a continuous 3 degree slope with no step ledge or level ledge; it also extends from interior to exterior. This inserted pre-cut sill extrusion lacks a water-tight seal on what would be considered the right and left frame sill jambs connections, this does not include the most interior wall (12) to interior structure. The positioning of movable sash or panel in its closed position is very critical for air infiltration in wall 12 also sill of sash or same as movable panel (not shown) and window locking rail or same as sash header (not shown). All items above need to be in timing with one another for new sill member to work in conjunction with replacement window. The current invention does not have these challenges with its air infiltration and water-tight connections that are incorporated in the original manufacturing equipment of the product.

Headrick U.S. Pat. No. 6,219,971 B1 (2001) shows additional rubberized or foam seal pads fixed to the bottom ends of both right and left door vertical frame jambs. This is where vertical door jambs/mullions are joined together with their slope angled threshold sill. These watertight seal pads reinforce and are added to the existing foam seal that extends periphery around closed door which was the original sealing method. The need for this added foam seal is primarily due to blowing rain or melting snow, where wind can easily blow rain or snow between the bottom closed door vertical frame jamb/mullion and sloped sill threshold entryway. The most common location for such leakage to occur is at the bottom corners of the door where the vertical frame jambs/mullions of the entryway meet the sloped threshold cap of the sill assembly. The foundational joining of these two parts is one of multiple compound angles. The present choice of joining or connecting these compound angled parts is machine or notching. This manufacturing art process is one that has shown to be difficult in consistently reproducing each connection. The joining of these foundational compound angles is one that poses a very critical construction step for overall door frame function and squareness which extrapolates as consumer door size requirement can increase in size. The current invention connection allows all movable panels inside door to open and close freely squarely and when closed seal properly. This additional sealing pad could be viewed as a remedy for unsquared connection at the joining frame sill threshold location of compound angles. Headrick explains this sealing pad to be formed with a downwardly extending ear that would be installed closest to the door frame sill or door threshold cap. Also this pad can have a bulbous shape in conjunction with the extending ear which in some cases can be an excessive amount of material to be pinched or extended amount of force to be applied to operating hinges. The current invention with its pre-engineered connection calculates all necessary trigonometry formulas needed to achieve proper vertical, lateral and interior/exterior axis angles. This also includes multiply tiered compound angled frame threshold cap to produce consistent square accurate connections thus eliminating additional seal parts.

### BRIEF SUMMARY

The current invention provides products that are exposed to exterior weather conditions that require water and moisture to be channeled away from structure such as but not limited to, doors, windows, store front windows, skylights or the like that would benefit from a sloped sill downward angled water drainage connection system. This would encompass but would not be limited to residential housing, manufactured housing, commercial buildings, recreation vehicles (RV) and the like.

Old style windows and doors used in residential, commercial and manufactured housing industries were typically comprised of wood. The majority of these wood windows and doors were made with sloped sills which are in some cases still the product of choice in markets today. While very good insulating factors currently exist in these wood products they were constructed to deflect and properly drain any moisture and water build up due to rain wind or snow. Any puddling of moisture or water could create “wood rot” and possible interior structural damage. These wood products were constructed with sloped angled sills or downward angled threshold sills that extended past the exterior face of the window, door product itself or structure to safely drain exterior water, rain, snow or moisture away from the structure it was secured in.

In today's market as technology has improved the most common window or door of choice can be made with vinyl, vinyl composites, proprietary composites, fiberglass, wood, aluminum, steel or some percentage of all although not limited to any materials. The current invention is compatible with all materials. When vinyl welded corner windows are manufactured each linear extrusion piece is cut to size with a 45 degree angle cut on both ends of each linear profile. Both lineal profiles need to share one common wall for the joining and water tight connection. This is processed through vinyl heat welding to complete one welded 90 degree corner. These profile linear extruded materials can with stand the slow melting process while each part is engaged and re-joined with each other as the part cures and temperature reduces. While this heat fusion process/welding takes place, one part can melt at a different rate than its mating partner. Industry can refer to this as “melt-back”. This can cause product to be unsquared when the re-joining or curing process occurs. This can cause many different quality defects such as movable sash or panel not to open or close properly, glass cracking, air leakage, water leaks can appear in unsquared corners, water leaks can also appear in unflatten linear surfaces due to unsquared racking of linear parts welded, sashes don't line up properly with frame meeting rail to engage locking mechanisms, outer frames roll causing movable sash/panel not to slide properly. This takes place at the heat welding process. The quality of larger sized finished product is affected more than smaller size finished product. Although manufactures have taken steps and made some adjustments to allow for this heat welding melt-back which mostly is contributed to increasing tolerance requirements which in some cases lower's the product potential performance. The current invention addresses these heat welding melt-back obstacles and produces astonishing square finished parts and product. While incorporating the current invention within the existing product or incorporating the current invention to a new product system, cut part formulas would need to be adjusted due to the achievement of increased squareness. The new pre-engineered assembled cut part sizing formulas would produce tighter tolerances thus producing higher U-factors and R-factors ratings for the end consumers.

Today in the door manufacturing industry there are multiple materials used include but are not limited to fiberglass, steel, wood, vinyl, aluminum and composites, each material having its own attributes. One common item used on doors is downward angled sloped threshold sill presently the material of choice due to its longevity is aluminum. Often times the door's vertical frame mullion jambs are cut or notched to be mated with the angled aluminum sloped threshold sill or in some cases the aluminum sloped threshold sill is notched to except this prefabricated angle on the vertical frame mullion jamb. Other door configurations offer decorative side lites of glass which require two vertical frame mullions on each side of swing-in or swing-out door that requires the same cut, notching process at the sloped threshold sill portion of the entry door. This new invention would eliminate the notching process requirement and provide sloped downward angled threshold sill water-tight connections.

Today store front windows are predominantly constructed using some form of rectangle or square aluminum extruded profile tubing with different styles of treated extrusions, painted with consumers choice of glass, glass thickness, glass tint, glass coating etc. The edges of these raw pieces of glass are surrounded by the aluminum extrusions along with their compatible water sealing materials. When requested or specified this aluminum extruded tubing can be thermally broke which separates the aluminum conductivity of exterior ambient temperature to interior ambient temperature by way of some form of joining rubber to mating aluminum extrusions to break the conductivity process. Some store fronts products can be constructed on site or remotely. When completed the exterior horizontal transoms pieces of this store front square tubing must include some form of sluice system, weep hole system to allow moister or water drainage. Normally this sluice system has interior water drainage (meaning inside aluminum tubing) through pre-punched or pre-drilled holes or cavities. This water travels from an upper most highest point of the store front to a lower most horizontal store front transom or closest to ground level. In some cases, code restrictions may restrict over all store front product heights due to water drainage potential capacity. In some cases, to meet water drainage building requirements the remedy product of choice turns into glass curtain wall application. This water drainage capacity requirement can be eliminated with this new embodiment downward propelling water-tight sloped threshold sill.

With the current cost of fuel and uncertain future fuel cost one of the most important features in designing recreational vehicle's (RV) are miles per gallon. Some products in the RV industry are motorized, others are towable. Regardless of RV choice, during the design stage aerodynamics or wind deflection to obtain maximum miles per gallon is of paramount importance. Currently there are towable RV trailers manufactured with very large severe angled sloped front ends allowing minimum wind deflection providing the consumer with less wind drag and increased miles per gallon. The window manufactured for this severe sloped application can only be produced in a non-operating configuration known in the industry as non-operating picture window. Because this window is designed to not open or allow no air or water to penetrate it creates uncomfortable camping conditions with no air infiltration or circulation. This severe sloped structure could benefit greatly from the current invention with downward propelling water-tight sloped threshold sill that can be designed in an operating (opening closing) window.

In summary, there are many products that are installed on the exterior structure. The current invention would insure downward propelling water-tight sloped threshold sill connections. The current invention along with its simplification would streamline the manufacturing process; eliminate machinery, lower labor, lower material usage lower energy cost and lower greenhouse polluting. The window and door industry would benefit from the current invention.

The present invention provides a window, door or store front framing/door product that is applicable to all building structures. This pre-molded downward propelling water-tight sloped threshold sill connection would eliminate any compound angle notching machinery needed in manufacturing process also insuring longitudinal, latitudinal square, air-tight and water-tight connections. This would open the opportunity for assembling and installing this product in the field. In some cases referred to as “site built” or “KD” (knock down) parts assembled in the field. Compound angle notching machinery is used in providing connection to vertical post or jambs which nest together with threshold angled sill or angled sill. This die notching or die cutting machine for the vertical jamb post for joining lineal profile parts has multiple methods for removing material to create desired angle for the mating of threshold angle sills. Material removed from vertical jamb post can be very minimal which after nested or joined to sloped threshold angle sill which creates the completed desired compound angle. These slightly processed angled parts are difficult producing the desired angled notching requirement. This minimally removed material or notching can alter the completed desired angle notch squareness, longitudinal and latitudinal quality.

The current disclosure related to a single connection having different ends wherein each of the ends sandwiches a portion of a respective lineal rail therebetween and is precisely fitted to sandwich with downward propelling sloped threshold sill and other end fitted to sandwich vertical post, jamb, or respective linear rail therebetween. When providing two, three, or four distinct ends with the front and back sides being of different contour or shape this creates right and left hand connections when facing either side of product, window, door or store front framing or the like. These sandwich portions on the same connection can be of the same lengths or different lengths. They can provide a flexible seal, incorporate door hinge pivot arm holes, balancer hooks, pre-molded notches, sluice weep-holes, piercings, accommodate and provide solar power cords and connections or the like. The same connection can sandwich different lineal shapes with or without each corner having the identical sandwich configuration on both ends of said same corner this allows any one connection to be connected to multiple different linear profiles thus keeping required connection pieces needed to a minimum.

The precision of molding manufacturing process provides that spline configurations or sandwiching sections at different ends of the connection or corner pieces are the precise configuration, including the desired size and shape for attaching, docking, imbricate, ribband, scarf, mechanically joining, sliding, slip fitting or the like on extruded linear profile parts. One or more of these sandwich ends on the same connection could incorporate angled linear connections. This sandwich portion with respective linear rail therebetween makes it production and user friendly when attempting to hold tight tolerances on the exterior portion of any extruded wall of profile. This exterior profile/extrusion wall thickness and shape is much more controllable by the extrusion process than other profile/extrusion walls contained within the same profile. When closing panel or sash on exterior main frame sloped threshold sill this new embodiment allows connections to the door panel sill or window sash sill itself to conform with same or incorporate rhombus, paralleled sloped sill angles that would provide tighter air and water-tight seals when product is in its fully closed position. In window, door applications, and pre-molded integral spline configurations, sandwich connections can be joined mechanically or un-mechanically to straight linear profiles pieces to achieve required water tight features. These pre-engineered connections parts would consistently produce accurate angled connections thus ensuring the operating parts within the exterior main frame to seal and generate better U-factor (heat transfer or loss ratings) & R-values (resistance to heat loss or conductivity ratings) with no need for added seal pads and parts.

With respect to pre-formed connection pieces, the configurations of splines at each end of the connection pieces feature various shapes and sizes, sometimes with tapered, angular profiles to facilitate a process of manual press fitting and joint sealant application to achieve a complete, air-tight and water-tight, connection when joining to the linear pieces. In some cases, the mere mechanical fit provides the connections needed rigidity and water-tightness. In other cases, a suitable adhesive can be used to form a secure bond in these sandwiched joints to achieve a water-tight connection.

To achieve this sandwiching effect with predictable tolerances it is important to use on any given linear the outside wall or most exterior wall to sandwich. These outside walls can be controlled in the extrusion process which allows the sandwich process to be water and air tight. Moldable corners have the highest tolerances and are the most predictable.

Accordingly, these downward propelling sloped threshold sill connections can ensure all axis's mathematically which includes trigonometric functions cosine and sine of any angle can consistently be reproduced in all manufacturing processes, therefore ensuring all movable and operating parts contained within interior portion of the exterior main frame move and seal squarely. This increases material choices to be sandwiched to one another in some cases decreased material weight per foot can provide equivalent or increased performance testing results. These connections can be although not limited to, vinyl to vinyl, vinyl to fiberglass, vinyl to aluminum, vinyl to wood, fiberglass to fiberglass, composite to composite, etcetera. This would create overall reduction in material usage demand along with increased thermos performance. Another increased savings would be during the manufacturing and assembling process wherein all single cut 45 degree miter parts needed prior to any heat welding or joining process would be eliminated. Each one of these individual single cut 45 degree miter cut parts whether exterior or interior must withstand excessive handling because they are individually processed that exposes itself to the overall quality performance within that particular product. When sandwiching square cut linear parts to their mating connections would extremely decrease necessary handling requirements improve productivity due to the ability to gang cut straight linear parts with one cycle or motion on straight cut chop saw. This would also decrease scrap parts wherein unwanted or unneeded larger pre-cut parts could simply be cut back into smaller parts when desired consumer order sizes dictate.

According to certain embodiments, all transparent translucent 90 degree sharp corner material is fixed to an exterior frame face. This exterior material is of larger size than its interior mating material when joined to make one complete insulated unit. This transparent or translucent material can be cut in strips and applied onto frame flange of retro fit products. In certain embodiments, a water weep hole is incorporated into exterior and interior molded corners.

According to certain embodiments, a frame is provided which includes a first linear rail, a second linear rail, and a first connection element that is configured to couple to both the first linear rail and the second linear rail. The first connection element may include a spline which extends in a vertical direction from the first connection element, an angled spline which extends in a horizontal direction from the first connection element, and a shroud comprising both a vertical portion which extends in a vertical direction from the first connection element and a horizontal portion which extends in a horizontal direction from the first connection element. In certain embodiments, the spline and the vertical portion of the shroud may be configured to sandwich a portion of the first linear rail therein. In certain embodiments, the angled spline and the horizontal portion of the shroud may be configured to sandwich a portion of the second linear rail therein.

According to certain embodiments, either the first or second linear rail of the frame is a sill which comprises a sloped surface. In certain embodiments, the angled spline comprises a sloped surface which corresponds to the sloped surface of the sill.

According to certain embodiments, the first connection element may include an interior weep hole and an exterior weep hole, wherein the interior weep hole is in fluid communication with the exterior weep hole.

According to certain embodiments, the frame also includes a third linear rail and a second connection element that is configured to couple to the first linear rail, the second linear rail, and the third linear rail.

In certain embodiments, the second connection element includes a first spline that extends in an upward vertical direction from the second connection element, a second spline that extends in a downward vertical direction from the second connection element, an angled spline that extends in a horizontal direction from the second connection element, and a shroud that includes both a vertical portion that extends in either vertical direction from the second connection element and a horizontal portion that extends in a horizontal direction from the second connection element. In certain embodiments, the first spline and the vertical portion of the shroud are configured to sandwich a portion of the first linear rail therein. In certain embodiments, the second spline and the vertical portion of the shroud are configured to sandwich a portion of the second linear rail therein. In certain embodiments, the angled spline and the horizontal portion of the shroud are configured to sandwich a portion of the third linear rail therein.

According to certain embodiments, the frame includes a fourth linear rail and a third connection element that is configured to couple to the first linear rail, the second linear rail, the third linear rail, and the fourth linear rail.

According to certain embodiments, the third connection element may include a first spline that extends in an upward vertical direction from the third connection element, a second spline that extends in a downward vertical direction from the third connection element, a first angled spline that extends in a first horizontal direction from the third connection element, a second angled spline that extends in a second horizontal direction from the third connection element, and a shroud which may include a vertical portion extending in either vertical direction from the third connection element and a horizontal portion that extends in either horizontal direction from the third connection element. In certain embodiments, the first spline and the vertical portion of the shroud are configured to sandwich a portion of the first linear rail therein. In certain embodiments, the second spline and the vertical portion of the shroud are configured to sandwich a portion of the second linear rail therein. In certain embodiments, the first angled spline and the horizontal portion of the shroud are configured to sandwich a portion of the third linear rail therein. In certain embodiments, the second angled spline and the horizontal portion of the shroud are configured to sandwich a portion of the fourth linear rail therein.

According to certain embodiments, the frame also includes a sash removably coupled to the frame.

According to certain embodiments, the sash may include a first linear sash rail, a second linear sash rail, and a first sash connection element that is configured to couple to both the first linear sash rail and the second linear sash rail.

According to certain embodiments, the second linear sash rail is a sash sill comprising a propelling acclivity.

According to certain embodiments, the first sash connection element may include a spline that extends in a vertical direction from the first sash connection element, an angled spline that extends in a horizontal direction from the first sash connection element, and a shroud comprising a vertical portion that extends in a vertical direction from the first sash connection element and a horizontal portion that extends in a horizontal direction from the first sash connection element. In certain embodiments, the spline and the vertical portion of the shroud are configured to sandwich a portion of the first linear sash rail therein. In certain embodiments, the angled spline and the horizontal portion of the shroud are configured to sandwich a portion of the second linear sash rail therein.

According to certain embodiments, the frame may also include a translucent or transparent insulated unit coupled to the frame, wherein the insulated unit includes a translucent or transparent covering configured to cover an entire exterior of the frame.

According to certain embodiments, the insulated unit may be configured to fit over an interior glazing channel defined within the frame.

According to certain embodiments, the insulated unit may include at least one multi colored glazing strip portion.

According to certain embodiments, the insulated unit may include a portion with at least one weep hole defined therein.

According to certain embodiments, the insulated unit may include a first transparent or translucent panel coupled to a second transparent or translucent panel to from the insulated unit.

According to certain embodiments, the insulated unit may include a plurality of corners, wherein each of the corners forms a right angle.

According to certain embodiments, the second transparent or translucent panel is smaller relative to the first transparent or translucent panel.

According to certain embodiments, the insulated unit may include a plurality of corners, wherein each of the corners comprises a rounded edge.

According to certain embodiments, the first connection element may be configured to form an air-tight and water-tight seal with both the first linear rail and the second linear rail.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

FIG. 1 is an exploded perspective view of a vertical slide single hung window constructed showing the aluminum door threshold angled sloped sill joined with linears. A transparent or translucent material is used for the both interior fixed and interior sash portions. The sharp 90 degree corner exterior of the transparent or translucent material is shown covering the entire exposed frame portion or can be broken up to cover different sections with multi colored paint applied to one or more interior or exterior surfaces, thereby providing an all transparent or translucent look from exterior.

FIG. 2A is an exploded perspective view of a horizontal slide window constructed showing a flat sill with right and left exterior molded corners that incorporate both interior and exterior sluice weep hole system in each individual connection.

FIG. 2B is a magnified perspective view of the left exterior molded corner seen in FIG. 2A.

FIG. 2C is a magnified perspective view of the left exterior molded corner and sill seen in FIG. 2A.

FIG. 3 is an exploded perspective view of a vertical slide window with rounded corner connections incorporating the features of the invention installed in a recreational vehicle with door threshold angled sloped sill.

FIG. 4 is an exploded perspective view of a swing out entry door with side lights constructed with threshold angled sloped sill connections to vertical frame mullions along with parallel angle connections.

FIG. 5 is an exploded perspective view of a store front window constructed with threshold angled sloped sill connections at multiple level widths to vertical frame mullions, horizontal transoms with two way and three way connections to sloped saddle threshold sill. These sloped saddle threshold sills meet all requirements needed for American Disabilities Act or ADA along with door panels that have parallel angle connections in accordance with the invention.

FIG. 6A is an exploded perspective view of a vertical slide single hung aluminum angled sloped threshold sill door corner connection to main frame exterior outer vertical frame jamb. Included in this exploded perspective view is a vertical operating interior sash/panel sloped angle sill that when closed on door threshold sloped angled sill forms parallel angles when in a closed position.

FIG. 6B is a magnified perspective view of the corner connection between the sill and frame jamb seen in FIG. 6A.

FIG. 7A is an exploded perspective view of an out swing entry door with exterior vertical mullion connection to aluminum threshold angled sloped sill along with interior swing out door panel sloped sill that form parallel angles when in the closed position.

FIG. 7B is a magnified perspective view of the three-way connection frame mullion threshold seen in FIG. 7A.

FIG. 8A is an exploded perspective view of store front window 4-way connection incorporating exterior profile in unspecified material to form threshold sloped angled horizontal transoms connecting with parallel angle vertical mullions.

FIG. 8B is a magnified perspective view of the four-way connection seen in FIG. 8A.

FIG. 9A is an exploded perspective view of a two-way connection main frame sloped threshold sill to mullion right hand saddle threshold sill compliant with American Disabilities Act (ADA) also in view is a three-way connection provided with three distinct ends that each end sandwiches a portion of a respective linear rail therebetween. This one three way connection connects to profile main frame sloped threshold sill then to profile main frame saddle threshold sill then to profile main frame vertical mullion.

FIG. 9B is a magnified perspective view of the two-way connection main frame sloped threshold sill to mullion right hand saddle threshold sill seen in FIG. 9A.

### DESCRIPTION OF THE PREFERRED EMBODIMENTS

The downward propelling water-tight sloped sill connection with American Disabilities Act (ADA) compliancy by the present disclosure is particularly applicable to windows and doors of any style.

The current invention is particularly applicable to vertically or horizontally hung windows, recreational vehicles windows, out-swing or in-swing doors with or without side lights with transparent or translucent panes sliding patio doors (not shown), store front window and doors or the like.

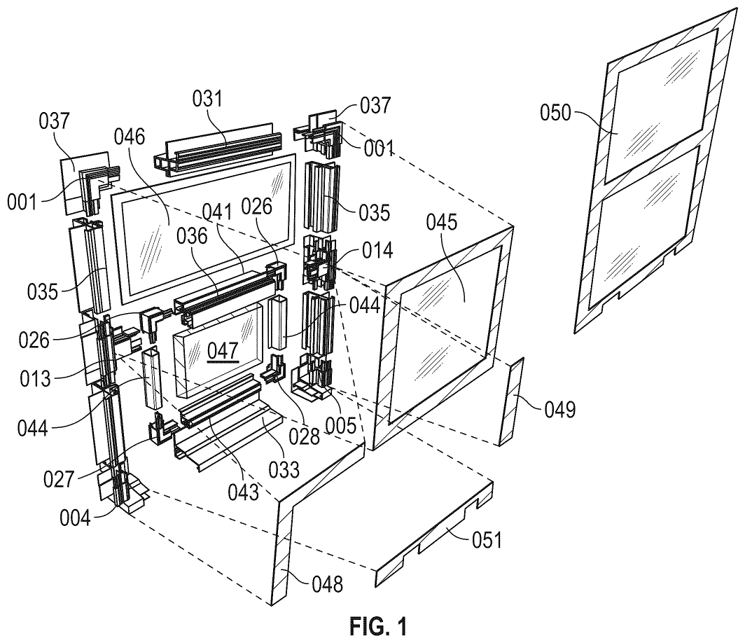

A window having an outer exterior main frame with a sliding interior sash is shown in FIG. 1. The exterior portion of the main frame head end comprises two identical parts, left hand and right hand that connect the exterior frame head 001 to exterior frame left and right hand frame jamb. This connection has identical ends wherein both ends sandwich a portion of a respective linear rail profile frame head 031 and profile frame jamb 035 therebetween. The exterior frame sill connection comprises of two way connection frame threshold 004 sill left hand and 005 two way connection frame threshold right hand. This connection has different ends wherein one end sandwiches a portion of a respective linear rail 035 profile frame jamb, the other end sandwiches a portion of 033 profile frame sloped threshold sill. Included in this exterior outer framework is three way connection frame meeting rail left hand 013 and three way connection frame meeting rail right hand 014. Two sides of this three way connection sandwich a portion of the linear rail therebetween 035 profile frame jamb, the third side of this connection in this same part sandwiches a portion of linear rail therebetween 036 profile frame meeting rail.

As used herein, “sandwich”, “sandwiches”, or “sandwiching” refers to a physical act, namely providing interlocking, interdigitated, or alternating surfaces between two objects that when brought together, interact, engage, or couple with each other so to provide an air-tight or water-tight seal there between.

Incorporated in both of these three way molded parts 014 and 013 at the 036 frame meeting rail connection are glass centering blocks. The interior sash panel framework may be single or multiple members holding translucent, transparent panes of glass or solid non-transparent cores for doors panels.

FIG. 1 shows two way connection interior sash head to jamb 026. This connection has identical ends wherein one end sandwich a portion of respective linear rail therebetween. One side of part 026 connects to 041 profile sash head and the identical end on the opposite side of the two way connection sandwiches 044 profile sash jamb. This allows both sides of identical two way connection 026 to sandwich a portion of linear profile sash head 041 and linear profile sash jamb 044 therebetween, therefore one two way connection 026 can accept two different linear profiles 041 and 044 thus allowing interior sash panel to function in conjunction with exterior main frame eliminating the need for multiple two way connection parts. The lower portion or sill end of this interior sash shows two way connection sash sill sloped left hand 027 which sandwich a portion of linear rail 043 profile sash sloped sill. The opposite end of this same two way connection sandwiches a portion of profile sash jamb 044. The right hand side of this sash shows two way connection sash/panel sill sloped right hand 028. According to some embodiments, when profile sash sloped sill 043 rest in its closed position against exterior profile frame sloped threshold sill 033 it creates parallel angles to meet and form water-tight and air-tight seals.

According to certain embodiments, the transparent or translucent interior material for the top portion 046 is to be joined with exterior transparent or translucent piece 050 which then would be referred to as one insulated unit with exterior piece being larger than interior piece. This unit comprises two glazing surfaces one for interior 046 which would be glazed to 001, 031, 035, 013, 036, 014. The exterior piece 050 would be glazed to 001, 031, 035, 013, 036, 014. This exterior transparent or translucent piece with sharp 90 degree corners can be one piece 050 and cover the entire exterior exposed frame and can include water weep holes pre-notched shown at the bottom of 050 and shown in multi-sided glazing section with weep-hole slots 051. This one piece insulated unit can be filled with argon gas or other gases as is known. The full transparent or translucent piece comes in different sections top or fixed 045 two sided multi sided glazing sections 048 one piece strips 049. These one piece strips 049 can be applied to retro-fit windows exterior frame flanges (not shown). The interior sash transparent translucent piece 047 would be sealed to exterior sash piece (not shown) of the same size to make one insulated unit and could be filled with argon gas or the like.

FIGS. 1, 2 and 3 illustrate the profile frame mounting flange 037 this is used for mounting exterior framework in a window aperture of commercial building, residential home, prefabricated house or a recreational vehicle. In certain embodiments, various glazes or glazing methods may be used on different components including transparent translucent glazing method three-way exterior fixed glazing 045, one-way interior fixed glazing 046, one-way sash glazing 047, multi sided glazing sections 048, multi colored glazing strip sections 049, four-way exterior fixed glazing 050, multi-sided glazing section with weep-holes slots 051 as shown in FIG. 1.

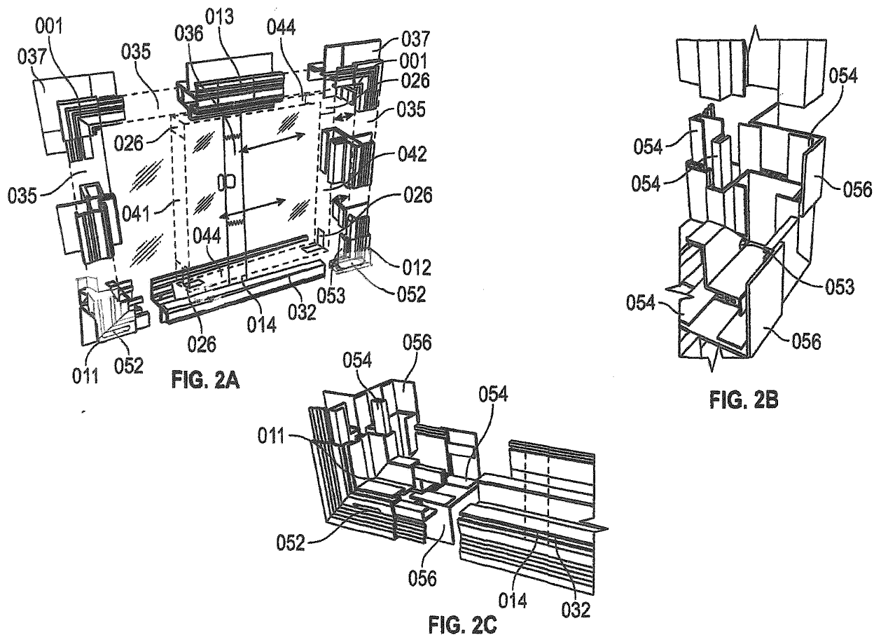

FIGS. 2A-2C shows horizontal sliding window in which the current apparatus is applied at left and right exterior three way connection frame sill left hand 011 and three way connection frame sill right 012 with a non-sloped flat exterior frame sill 032. During the molding process these exterior connection corners 011 and 012 have predetermined exterior weep-hole slots 052 along with interior weep-hole slot 053. This eliminates added machining needed on production floor. This horizontal sliding window has a sash that slides from right to left. It is constructed with exterior profile frame head horizontal 035 and frame jamb right and left 035. Two way connection frame head to jamb 001 for left and 001 for right. Three way connection frame meeting rail left hand 013 and three way connection frame meeting rail right hand 014. Sash is constructed with profile sash panel head for horizontal 044 this 044 is also used for sash sill. Two way connection sash panel head to jamb 026 for all four corners of sash. Sash left jamb is profile sash panel head 041. Sash right jamb is profile sash panel sill 042.

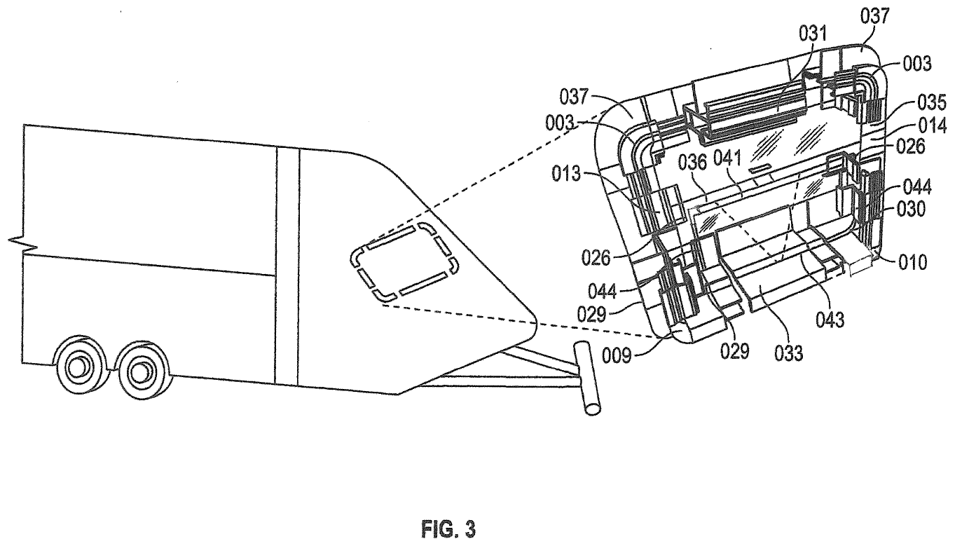

FIG. 3 shows invention installed in sloped front cap of aerodynamic recreational vehicle. This product application requires two each two way connection frame head rounded 003. One each two way connection frame threshold sill rounded L/H 009. One each two way connection frame threshold sill rounded R/H 010. One each two way connection sash sill parallel angle sloped rounded L/H 029. One each two way connection sash/panel sill sloped rounded R/H 030. This embodiment requires larger degree angles on profile frame sloped threshold sill 033 along with larger degree angle on profile sash sloped sill 043, larger degree not shown.

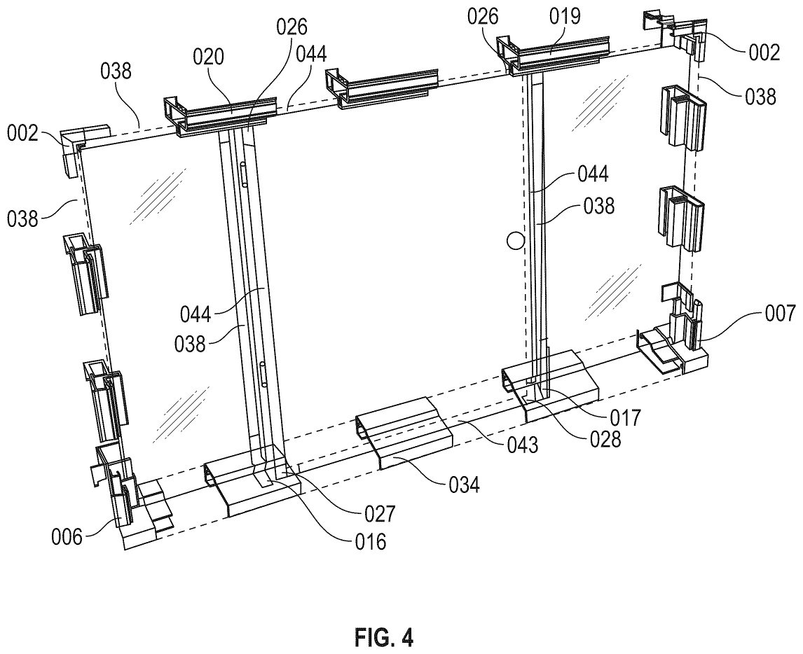

FIG. 4 shows entry door with side lights on right and left hand side hinged left with an out-swing door panel. The entry door comprises a profile frame mullion/transom 038 and a two way connection frame horizontal transom to vertical mullion 002 on both top left and right sides. Both ends of these connections are identical wherein each of the ends sandwiches a portion of 038 respective linear rail therebetween. Profile frame/mullion 038 makes a vertical connection to the other side of 006 two way connection frame threshold to mullion L/H makes connection to 034 profile frame sloped threshold door sill. The right hand side of main frame sloped threshold sill makes one of the two way connection into 007 described as two way connection frame threshold to mullion R/H. The other side of 007 of this two way connection has a different end that sandwich 038 which is described as profile frame vertical mullion/transom. Profile frame mullion/transom 038 makes a three way connection frame mullion threshold fixed left 016. The three way connection frame mullion R/H 020 connects the head portion of 038. The right side of opening panel with door handle has profile frame vertical mullion 038. On the sill end of this 038 there is a three way connection frame mullion threshold fixed right 017. The head end of this same vertical mullion has a three way connection frame mullion L/H 019. When this door panel opens and closes it has a parallel angle 043 which is profile sash sloped sill 043. The closed position of this door panel creates parallel angles to meet which are 034 and 043. This creates a water-tight and air-tight seal.

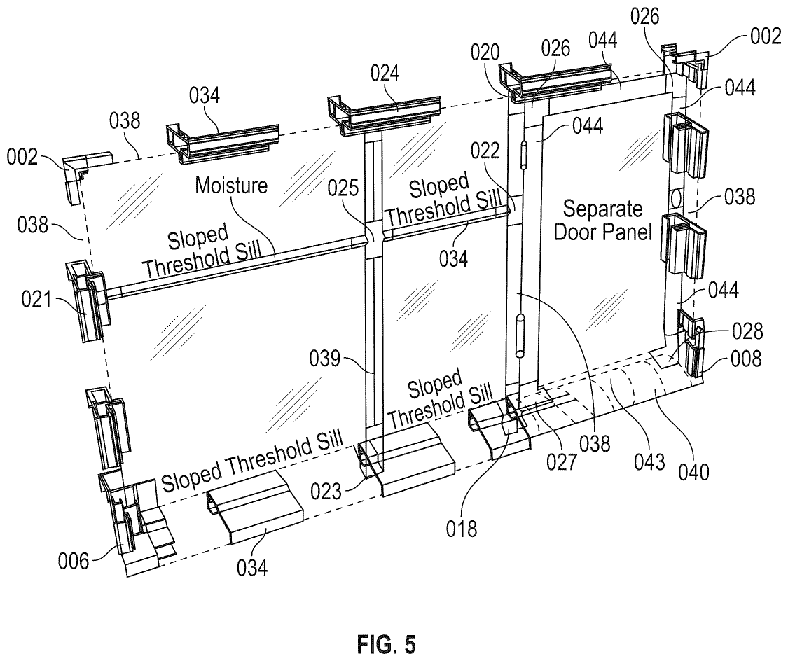

FIG. 5 illustrates a store front window with left hand hinged out-swing door panel according to certain embodiments. There is a three-way connection frame threshold mullion fixed left and right 023. Each of the two lateral or horizontal sides of the three-way connection frame 023 are identical and sandwich a portion of a respective linear rail profile therebetween 034. The remaining side or in this case the vertical side of this three way connection frame 023 sandwich a portion of a respective linear rail profile 039 described as profile frame double mullion/transom. The top or head end of this vertical double mullion/transom 039 that couples to profile frame mullion/transom 038 comprises a three way connection 024 which is a three way connection frame mullion fixed left and right which allows for fixed glass on both the left and right hand sides of connection 024. Three way connection frame threshold mullion right hand 022 comprises two identical vertical connections that sandwich a portion of respective linear rail 038 therebetween. According to certain embodiments, the three-way right handed connection 022 is coupled to a linear rail 034 which according to certain embodiments is a profile frame sloped threshold sill. A three way connection frame threshold mullion left handed 021 is disposed on the left hand side of this store front window. A four way connection 025, which according to certain embodiments is a four way connection frame mullion to sloped threshold sill, incorporates a sloped threshold sill 034 in two horizontal directions and sandwich a portion of the respective linear rail 034 between it and the three-way right handed connection 022. The vertical connections of the four way connection 025 incorporates the sloped threshold sill angle on the underneath surface of the linear rail 034 and an upward or parallel connection on the top surface of the linear rail 034. Both sides of this upper and lower connections sandwich a portion of respective linear vertical rail therebetween 039. The exterior frame right hand bottom sill portion shows two way connection frame threshold to mullion right hand left American Disability Act (ADA) 008. One side of this two way connection which makes up a single corner 008 having different ends wherein each of the ends sandwich a portion of a linear rail therebetween 038 and angled profile frame threshold ADA sill 040. The left hand side of this entry door way has a three way connection main frame vertical mullion sloped threshold fixed left ADA 018. All three sides of this three way connection provide separate ends that each end sandwich a portion of a respective linear rail therebetween. The vertical connection connects to 038 described as profile frame mullion/transom. The left hand connection connects to 034 described as profile frame sloped threshold door sill. The right hand side of this connection connects to 040 described as profile frame threshold sill American Disability Act which is ADA compliant.

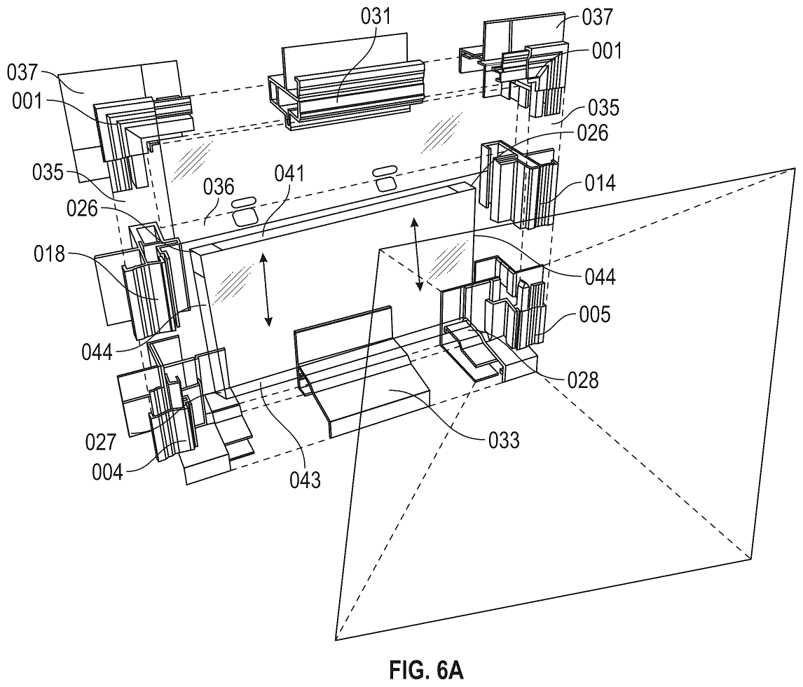

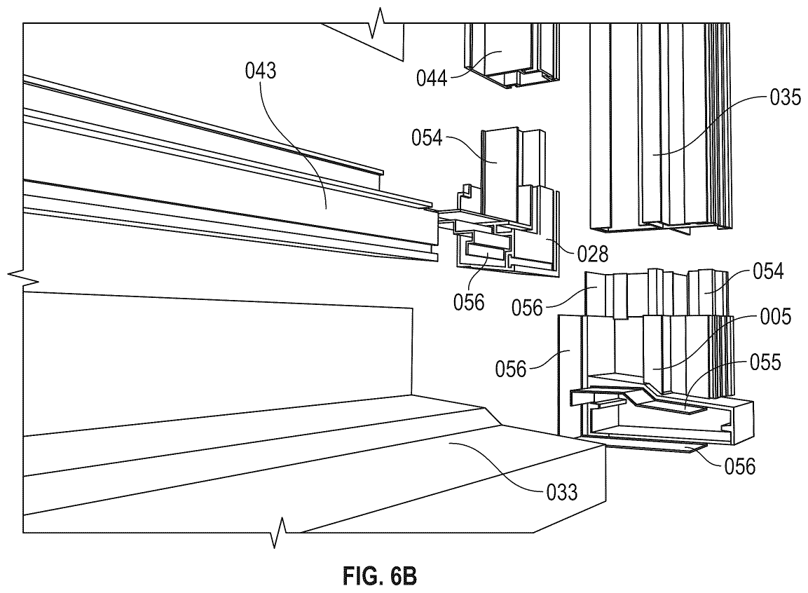

FIGS. 6A and 6B show a window with an exploded perspective view of right hand outer exterior main frame two way connection corner 005. This two way connection 005 has two distinct ends. The vertical end sandwiches a portion of the profile frame jamb (head for horizontal) respective linear rail 035 therebetween. The sill end or in this case the horizontal end of this two way connection connects to aluminum profile frame threshold sloped sill 033 which also sandwich a portion of the respective linear rail therebetween. Also included in this exploded perspective view is two way connection sash sill sloped 028 for the operating interior sash/panel that also has two distinct ends. The vertical end of this two way connection sandwich a portion of the respective linear rail 044 described as profile sash jamb therebetween. The sill end or in this case the horizontal end of this two way connection connects to interior profile sloped angle sill 043 this sloped angle matches the same sloped angle of the aluminum door profile main frame exterior threshold sloped sill 033. In the closed position this creates air-tight and water-tight parallel angles. Profile frame sloped threshold sill 033 aluminum linear rail is lined up to be slid into one single connection corner 005 that has different ends wherein one end has shroud 056 and angled spline 055 sandwiches a portion of the respective linear rail 033 therebetween. On the opposite end of 005 are spline 054 and shroud 056. Profile frame jamb 035 linear rail will then sandwich a portion therebetween making this connection water and air tight. Profile sash sloped sill linear 043 has downward angled identical to profile frame sloped threshold sill linear 033. This two way connection sash sill sloped right hand 028 corner has different ends. The sloped end has shroud 056 and spline 054 that sandwich a portion of profile sash sloped sill linear 043. On the opposite end of two way connection sash sill sloped right hand linear 028 has shroud 056 and spline 054 that sandwich a portion of profile sash jamb 044.

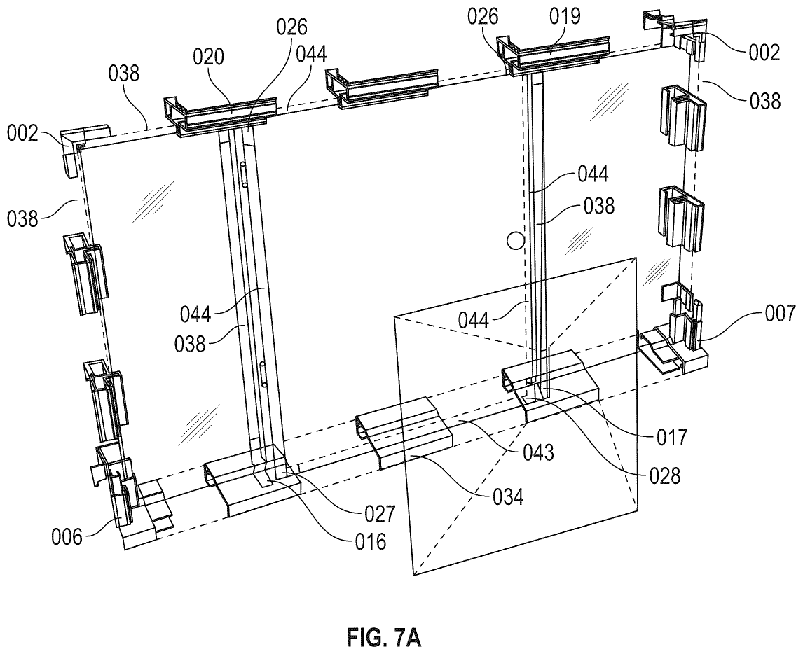

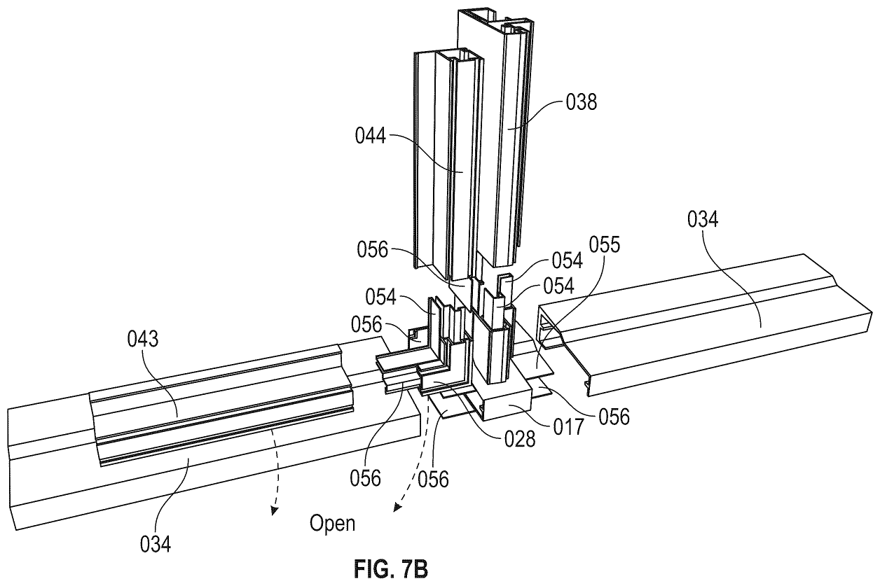

FIGS. 7A and 7B show an out-swing entry door with a exploded perspective view of right hand outer exterior main frame three way connection 017. This three way connection 017 has three distinct ends. The vertical end sandwiches a portion of the respective linear rail profile main frame mullion 038 therebetween. The sill end or in this case the two horizontal ends of this three way connection 017 connects to aluminum profile main frame sloped threshold door sill 034 which also sandwiches a portion of the respective linear rail 034 therebetween. Also included in this exploded perspective view is two way connection 028 for the operating interior sash door panel 028 that also has two distinct ends. The vertical end of this two way connection sandwiches a portion of the respective linear rail described as profile sash/panel jamb 044 therebetween. The sill end or in this case the horizontal end of this two way connection described as profile sash sloped sill 043 this sloped angle matches the same sloped angle of the aluminum door profile main frame threshold sloped sill 034. In the closed position this creates air-tight and water-tight parallel angles. This three way connection frame mullion threshold fixed right 017 having different ends has protruding horizontally on both sides spline 056, angled spline 055, and shroud 056 when in contact with sliding profile frame sloped threshold door sill 034 they sandwich a portion of linear 034 therebetween. Protruding from the vertical end of 017 is spline 054 and shroud 056. This facilitates a portion of profile frame mullion/transom linear 038 to be sandwich providing a water and air tight seal.

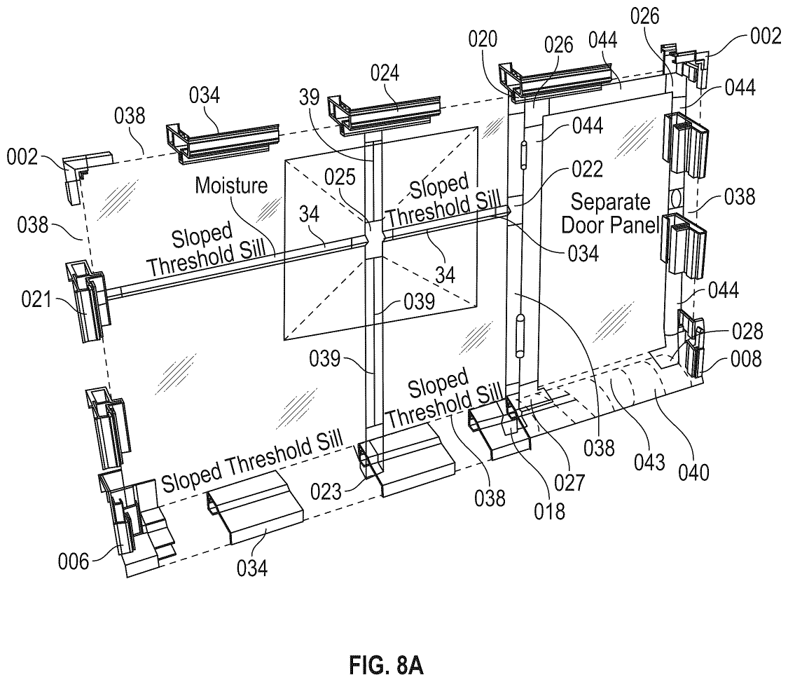

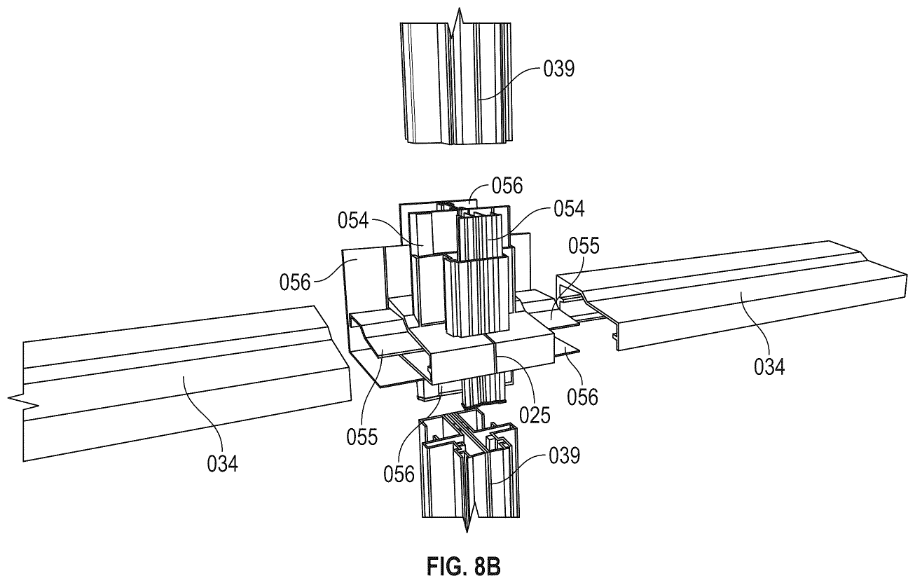

FIGS. 8A and 8B show a store front window with a exploded perspective view of four way connection 025. Of these four possible distinct ends on this connection 025 two of them sandwiches a portion of a respective linear rail 039 described as profile frame double mullion/transom for the vertical top and bottom connections the other two connections which in this case are for horizontal left and right connections of 034 which is aluminum sloped threshold sill that sandwiches a portion of the respective linear rail therebetween.

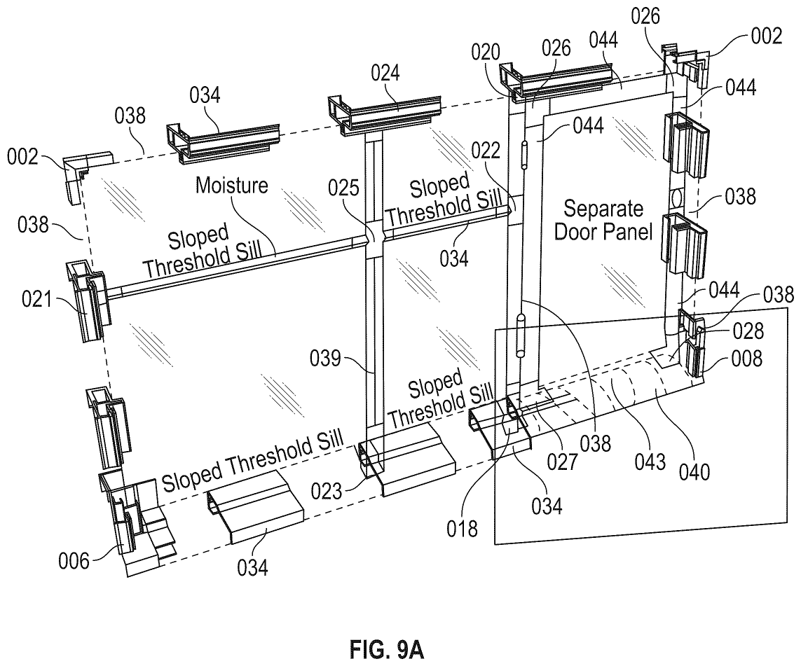

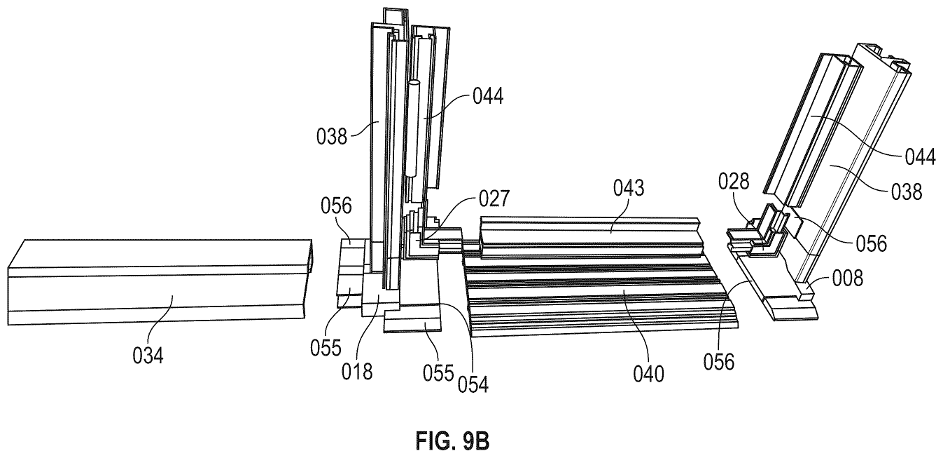

FIGS. 9A and 9B show store front exterior framing that holds an out-swing door. The bottom right hand sill corner shows two way connection 008. This two way connection 008 has two distinct ends. The vertical end sandwiches a portion of the store front respective linear rail described as profile frame mullion/transom 038 therebetween. The sill end or in this case the horizontal end of this two way connection connects to aluminum profile frame threshold sloped sill 040 that meets American Disability Act (ADA) requirements which also sandwich a portion of the respective linear rail therebetween. The left hand side of this entry door opening sill has a three way connection 018. All three ends of this three way connection sandwich a portion of a respective linear rail therebetween. The vertical end connection of this three way connection connects to 038 which is described as profile frame mullion/transom. The other two connections on the horizontal sill end of this three way connection connect to two different aluminum sloped threshold sills 034 on left hand side and 040 on right hand side. The left hand side is described as profile frame sloped threshold door sill 034. The right hand side is described as profile frame threshold sill 040 American Disability Act (ADA). Also included in this exploded perspective view is two way connection 028 for the operating interior sash/panel that also has two distinct ends. The vertical end of this two way connection sandwich a portion of the respective linear rail 044 therebetween. The sill end or in this case the horizontal end of this two way connection connects to profile sloped angle sill 043 this sloped angle matches the same sloped angle of the aluminum profile frame threshold sill that meets American Disabilities Act (ADA) 040. In the closed position this creates air-tight and water-tight rhombus or parallel angles.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A frame comprising:
a first linear rail;
a second linear rail; and
a first connection element configured to couple to both the first linear rail and the second linear rail,
wherein the first connection element comprises:
a spline extending in a vertical direction from the first connection element;
an angled spline extending in a horizontal direction from the first connection element; and
a shroud comprising a vertical portion extending in a vertical direction from the first connection element and a horizontal portion extending in a horizontal direction from the first connection element,
wherein the spline and the vertical portion of the shroud are configured to sandwich a portion of the first linear rail therein, and
wherein the angled spline and the horizontal portion of the shroud are configured to sandwich a portion of the second linear rail therein.

2. The frame of claim 1, wherein either the first or second linear rail is a sill comprising a sloped surface, and
wherein the angled spline comprises a sloped surface which corresponds to the sloped surface of the sill.

3. The frame of claim 1, wherein the first connection element comprises an interior weep hole and an exterior weep hole, wherein the interior weep hole is in fluid communication with the exterior weep hole.

4. The frame of claim 1, further comprising:
a third linear rail; and
a second connection element configured to couple to the first linear rail, the second linear rail, and the third linear rail.

5. The frame of claim 4, wherein the second connection element comprises:
a first spline extending in an upward vertical direction from the second connection element;
a second spline extending in a downward vertical direction from the second connection element;
an angled spline extending in a horizontal direction from the second connection element; and
a shroud comprising a vertical portion extending in either vertical direction from the second connection element and a horizontal portion extending in a horizontal direction from the second connection element,
wherein the first spline and the vertical portion of the shroud are configured to sandwich a portion of the first linear rail therein,
wherein the second spline and the vertical portion of the shroud are configured to sandwich a portion of the second linear rail therein,
wherein the angled spline and the horizontal portion of the shroud are configured to sandwich a portion of the third linear rail therein.

6. The frame of claim 4, further comprising:
a fourth linear rail; and
a third connection element configured to couple to the first linear rail, the second linear rail, the third linear rail, and the fourth linear rail.

7. The frame of claim 6, wherein the third connection element comprises:
a first spline extending in an upward vertical direction from the third connection element;
a second spline extending in a downward vertical direction from the third connection element;
a first angled spline extending in a first horizontal direction from the third connection element;
a second angled spline extending in a second horizontal direction from the third connection element; and
a shroud comprising a vertical portion extending in either vertical direction from the third connection element and a horizontal portion extending in either horizontal direction from the third connection element,
wherein the first spline and the vertical portion of the shroud are configured to sandwich a portion of the first linear rail therein,
wherein the second spline and the vertical portion of the shroud are configured to sandwich a portion of the second linear rail therein,
wherein the first angled spline and the horizontal portion of the shroud are configured to sandwich a portion of the third linear rail therein, and
wherein the second angled spline and the horizontal portion of the shroud are configured to sandwich a portion of the fourth linear rail therein.

8. The frame of claim 1, further comprising a sash removably coupled to the frame.

9. The frame of claim 8, wherein the sash comprises:
a first linear sash rail;
a second linear sash rail; and
a first sash connection element configured to couple to both the first linear sash rail and the second linear sash rail.

10. The frame of claim 9, wherein the second linear sash rail is a sash sill comprising a propelling acclivity.

11. The frame of claim 9, wherein the first sash connection element comprises:
a spline extending in a vertical direction from the first sash connection element;
an angled spline extending in a horizontal direction from the first sash connection element; and
a shroud comprising a vertical portion extending in a vertical direction from the first sash connection element and a horizontal portion extending in a horizontal direction from the first sash connection element,
wherein the spline and the vertical portion of the shroud are configured to sandwich a portion of the first linear sash rail therein, and
wherein the angled spline and the horizontal portion of the shroud are configured to sandwich a portion of the second linear sash rail therein.

12. The frame of claim 1, further comprising a translucent or transparent insulated unit coupled to the frame, wherein the insulated unit comprises a translucent or transparent covering configured to cover an entire exterior of the frame.

13. The frame of claim 12, wherein the insulated unit is configured to fit over an interior glazing channel defined within the frame.

14. The frame of claim 12, wherein the insulated unit comprises at least one multi colored glazing strip portion.

15. The frame of claim 12, wherein the insulated unit comprises a portion with at least one weep hole defined therein.

16. The frame of claim 12, wherein the insulated unit comprises a first transparent or translucent panel coupled to a second transparent or translucent panel to from the insulated unit.

17. The frame of claim 16, wherein the insulated unit comprises a plurality of corners, wherein each of the corners forms a right angle.

18. The frame of claim 16, wherein the second transparent or translucent panel is smaller relative to the first transparent or translucent panel.

19. The frame of claim 16, wherein the insulated unit comprises a plurality of corners, wherein each of the corners comprises a rounded edge.

20. The frame of claim 1, wherein the first connection element is configured to form an air-tight and water-tight seal with both the first linear rail and the second linear rail.
